(19) United States
(12) Patent Application Publication
(10) Pub. No.: US 2007/0251548 A1
(43) Pub. Date: Nov. 1, 2007

(54) Conveyor type wet-processing apparatus and treatment of substrate

(75) Inventors: Tehsin Lee, Dongshan Township (TW); Chia-Wei Lin, Cyonglin Township (TW); De-Bao Chan, Sinpu Township (TW); Sung-Yi Chou, Baoshan Township (TW); Benny Yang, Jhudong Township (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/402,587

(22) Filed: Apr. 11, 2006

(51) Int. Cl. B08B 3/00; B08B 1/02; B08B 7/00

(52) U.S. Cl. 134/26; 134/32; 134/61; 134/33; 134/137; 134/149

(57) ABSTRACT

A wet-processing apparatus for processing substrates is provided. The wet-processing apparatus for processing substrates includes a conveyor type cleaning system and a spinner type wet-processing unit connected to the conveyor type cleaning system. In an embodiment of the present invention, the wet-processing apparatus further includes a cassette station for storing the substrates and a robot installed in the cassette station, wherein the substrate is delivered from the cassette station to the conveyor type cleaning system by the robot. The wet-processing apparatus mentioned above has excellent process uniformity, low consumption of the chemical, good cleaning ability, and low substrate broken frequency.

### BACKGROUND OF THE INVENTION

1. Field of Invention

The present invention relates to a wet-processing apparatus. More particularly, the present invention relates to a wet-processing apparatus having a spinner type wet-processing unit and a conveyor type cleaning unit.

2. Description of Related Art

In recent years, a variety of electronic products are drastically developed due to the rapid development of the semiconductor device. Generally, semiconductor devices are fabricated by various processing apparatus, such as etcher, stripper and developer. Take wet-processing apparatus as an example, the wet-processing apparatus may be classified into a spinner type processing apparatus and a conveyor type apparatus. Conventional spinner type processing apparatus and conveyor type apparatus are described respectively as followings.

FIG. 1 is a schematic top view showing a conventional spinner type processing apparatus. Referring to FIG. 1, the conventional spinner type processing apparatus 100 includes a cassette station 110, a robot 120 and 130, transfer units 140a, 140b and 140c, an EUV (excimer ultraviolet) cleaning unit 150 and spinners 160. The robot 120 is installed in the cassette station 110. The transfer unit 140a connects the cassette station 110 and the EUV cleaning unit 150. The transfer unit 140b connects the EUV cleaning unit 150 and the robot 130. The transfer unit 140c connects the robot 130 and the cassette station 110. The spinners 160 connect to the robot 130. In addition, the robot 130 is surrounded by the transfer units 140a, 140b and 140c, the EUV (excimer ultraviolet) cleaning unit 150 and the spinners 160.

As shown in FIG. 1, the cassette station 110 is used to store wafers or glass substrates 170. The robot 120 is used to deliver the wafers or glass substrates 170 stored in the cassette station 110 to the transfer unit 140a. After the wafers or glass substrates 170 are delivered to the transfer unit 140a by the robot 130, the wafers or glass substrates 170 are transferred into the EUV cleaning unit 150. In the EUV cleaning unit 150, a surface treatment is performed by irradiating EUV on the wafers or glass substrates 170 to generate ozone (O₃) such that organic material on the wafers or glass substrates 170 is removed and contact angle of the wafers or glass substrates 170 is reduced by ozone. After the wafers or glass substrates 170 are pre-treated, the wafers or glass substrates 170 are transferred to the transfer unit 140b. Then, the wafers or glass substrates 170 are delivered to the spinners 160 respectively by the robot 130. In the spinners 160, wet process, cleaning process and spin-drying process are performed on the wafers or glass substrates 170 sequentially. After the wafers or glass substrates 170 are processed, the wafers or glass substrates 170 are delivered from the spinners 160 to the transfer unit 140c. Ultimately, the wafers or glass substrates 170 are delivered from the transfer unit 140c to the cassette station 110 by the robot 120 such that the wafers or glass substrates 170 can be store in the cassette station 110.

In the spinner type processing apparatus 100, consumption of the chemical used to perform the wet process in the spinners 160 is relatively low and the process uniformity is easy to control. However, during the spin-drying process, the wafers or glass substrates 170 may break and spin-mura occurred on the wafers or glass substrates 170 is easily induced because of the high rational speed. When the wafers or glass substrates 170 break, fragments of the wafers or glass substrates 170 are difficult to obviate. In addition, in the spinner type processing apparatus 100, particles dropped on the wafers or glass substrates 170 can not be removed effectively.

FIG. 2 is a schematic top view showing a conventional conveyor type processing apparatus. Referring to FIG. 2, the conventional conveyor type processing apparatus 200 includes a cassette station 210, a robot 220, an EUV cleaning unit 230, a wet-processing unit 240, a post-cleaning system 250, an air knife 260 and a dry conveyor 270. As shown in FIG. 2, the post-cleaning system 250 includes a brushing unit 250a, a wet conveyor 250b, a cavitation jet unit 250c and a mega-sonic unit 250d. The robot 220 is installed in the cassette station 210. In addition, the dry conveyor 270 connects the air knife 260 and the cassette station 210.

As shown in FIG. 2, the robot 220 is used to deliver the wafers or glass substrates 170 stored in the cassette station 210 to the EUV cleaning unit 230. After the wafers or glass substrates 170 are delivered to the EUV cleaning unit 230, the wafers or glass substrates 170 convey to the wet-processing unit 240, the cleaning system 250 and the air knife 260 sequentially. Specifically, in the EUV cleaning unit 230, a surface treatment is performed by irradiating EUV on the wafers or glass substrates 170 to generate ozone (O₃) such that organic material on the wafers or glass substrates 170 is removed and contact angle of the wafers or glass substrates 170 is reduced by ozone. After the wafers or glass substrates 170 are pre-treated, the wafers or glass substrates 170 are conveyed to the wet-processing unit 240 to perform wet chemical process. Then, the wafers or glass substrates 170 are conveyed to the brushing unit 250a, the wet conveyor 250b, the cavitation jet unit 250c and the mega-sonic unit 250d sequentially such that particles on the wafers or glass substrates 170 can be removed effectively. Then, the wafers or glass substrates 170 are conveyed to the air knife 260 such that the wafers or glass substrates 170 can be dried entirely. Ultimately, the wafers or glass substrates 170 are delivered to the cassette station 210 by the robot 220.

In the conveyor type processing apparatus 200, the ability of removing particles dropped on the wafers or glass substrate 170 is better because the particles can be easily removed by the brushing unit 250a and the cavitation jet unit 250c. Besides, the substrate broken frequency is lowered because the wafers or glass substrate 170 are dried by the air knife 260. Even if the wafers or glass substrates 170 break, fragments of the wafers or glass substrates 170 can be obviated rapidly. However, in the conveyor type processing apparatus 200, consumption of the chemical used to perform the wet process in the wet-processing unit 240 is much higher and the process uniformity is difficult to control.

Since the yield rate and cost of semiconductor devices are determined by process uniformity, consumption of the chemical, ability of cleaning, and substrate broken frequency etc., we need a wet-processing apparatus with excellent process uniformity, low consumption of the chemical, good cleaning ability, and low substrate broken frequency.

### SUMMARY OF THE INVENTION

The invention provides a conveyor type wet-processing apparatus having a spinner type wet-processing unit therein and treatment of substrates.

As embodied and broadly described herein, the invention provides a wet-processing apparatus for processing substrates including a conveyor type cleaning system and a spinner type wet-processing unit connected to the conveyor type cleaning system. In an embodiment of the present invention, the wet-processing apparatus further includes a cassette station for storing the substrates and a robot installed in the cassette station, wherein the substrate is delivered from the cassette station to the conveyor type cleaning system by the robot.

In an embodiment of the present invention, the conveyor type cleaning system includes a pre-cleaning unit disposed between the cassette station and the spinner type wet-processing unit, a post-cleaning unit connected to the spinner type wet-processing unit, and a conveyor disposed in the pre-cleaning unit and the post-cleaning unit. In the present embodiments, the substrates are conveyed from the pre-cleaning unit to the spinner type wet-processing unit and the post-cleaning unit sequentially by the conveyor.

In another embodiment of the present invention, the conveyor type cleaning system further includes a drying unit connected to the post-cleaning unit. In the present embodiments, the substrates are conveyed from the pre-cleaning unit to the spinner type wet-processing unit, the post-cleaning unit and the drying unit sequentially by the conveyor.

As embodied and broadly described herein, the invention provides a treatment of substrates. The treatment (e.g. a slice etch process, a wet etch process, a stripper, or a developer) includes following steps. A cleaning process is performed on the substrates by a conveyor type cleaning system. A wet-process is performed on the substrates by a spinner type wet-processing unit that is connected to the conveyor type cleaning system. In an embodiment of the present invention, the cleaning process includes following steps. First, a pre-cleaning process is performed on the substrates by a pre-cleaning unit. Then, a post-cleaning process is performed on the substrates by a post-cleaning unit after performing the wet-processing. Ultimately, a drying process is performed on the substrates by a drying unit connected to the post-cleaning unit.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view showing a conventional spinner type processing apparatus.

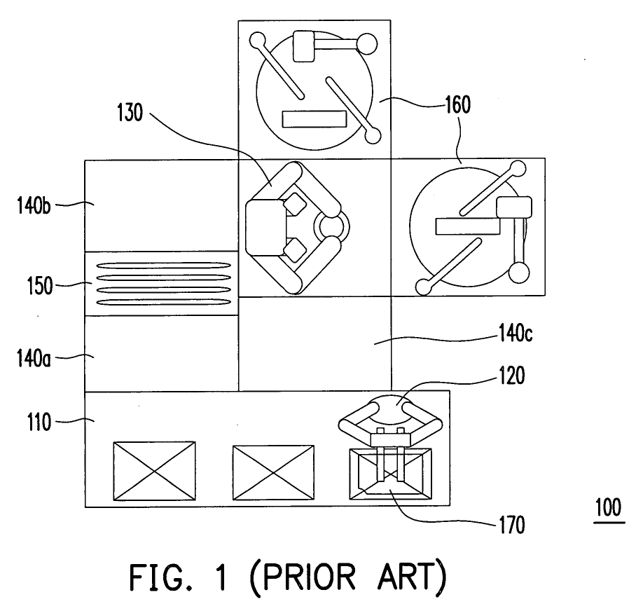

FIG. 2 is a schematic top view showing a conventional conveyor type processing apparatus.

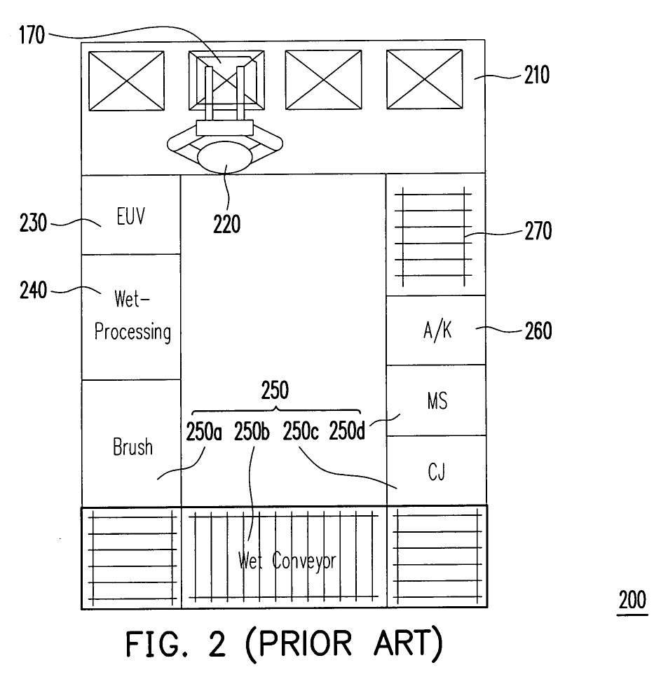

FIG. 3 is a schematic top view showing a wet-processing apparatus according to an embodiment of the present invention.

FIG. 4 is a schematic top view showing a wet-processing apparatus according to another embodiment of the present invention.

### DESCRIPTION OF THE PREFERRED EMBODIMENTS

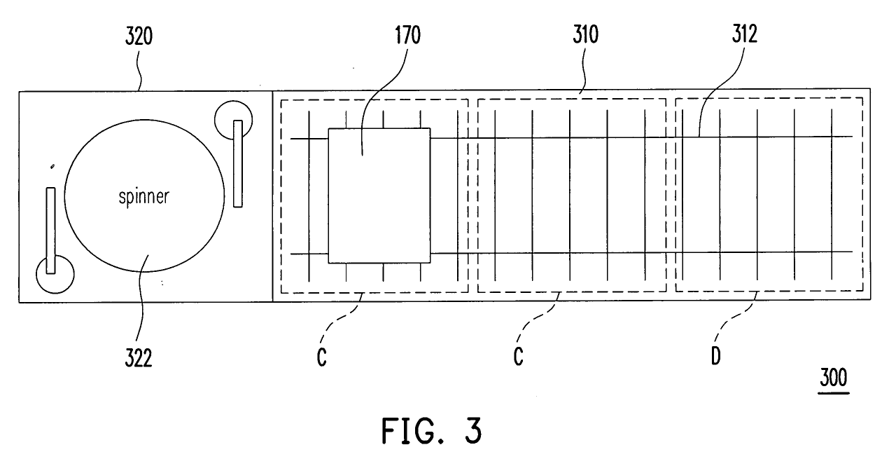

FIG. 3 is a schematic top view showing a wet-processing apparatus according to an embodiment of the present invention. Referring to FIG. 3, the wet-processing apparatus 300 of the present invention includes a conveyor type cleaning system 310 and a spinner type wet-processing unit 320 connected to the conveyor type cleaning system 310. In the present invention, the conveyor type cleaning system 310 may be defined as a cleaning system having a dry conveyor 312 for conveying substrates 170 processed. In addition, the spinner type wet-processing unit 320 may be defined as a wet-processing unit having a spinner 322 for spinning substrates 170 loaded thereon during wet-processes.

In the present embodiment, the conveyor type cleaning system 310 may include at least one cleaning unit C and at least one drying unit D. In the conveyor type cleaning system 310, the substrates 170 are conveyed to the cleaning unit C and the drying unit D by the dry conveyor 312 sequentially. Specifically, the conveyor type cleaning system 310 may includes one or more cleaning units C, which are selected from an excimer UV cleaning unit, a brushing unit, a wet conveyor, a cavitation jet unit, a mega-sonic unit or the combinations thereof. The arrangement of the cleaning units C is not limited in the present invention. Furthermore, the drying unit D of the conveyor type cleaning system 310 may be an air knife or other drying tools. Since the substrates 170 are cleaned and dried by the conveyor type cleaning system 310 without spinning, the ability of substrate cleaning is good and substrate broken frequency is lowered.

In the present embodiment, the spinner type wet-processing unit 320 may be an etcher, a stripper or a developer. When the spinner type wet-processing unit 320 is a slice etcher, a slice-etching process is performed on the substrates 170 by conducting diluted hydrogen-fluoride (DHF) and ozone (O₃); when the spinner type wet-processing unit 320 is a wet etcher, a wet-etching process is performed on the substrates 170 by conducting acid; and when the spinner type wet-processing unit 320 is a developer, an developing process is performed on the substrates 170 by conducting alkali. Specifically, the chemical needed to be conducted into the spinner type wet-processing unit 320 is provided by chemical showering. Since the chemical is provided by chemical showering, the spinner type wet-processing unit 320 of the wet-processing apparatus 300 can save a lot of chemical. In addition, the process uniformity of the wet-process performed by the spinner type wet-processing unit 320 is excellent. It is noted that, a chemical process (e.g. etch, a stripping or a development) can be performed repeatedly by the spinner type wet-processing unit 320. Also, various chemical processes (e.g. etch, a stripping, and a development) can be performed repeatedly by the spinner type wet-processing unit 320. In comparison with the prior art, the present invention can facilitate throughput when utilizing the wet-processing apparatus 300.

The arrangement and quantity of the conveyor type cleaning system 310 and the spinner type wet-processing unit 320 is not limited in the present invention. A preferred arrangement of the wet-processing apparatus 300 is described as followings.

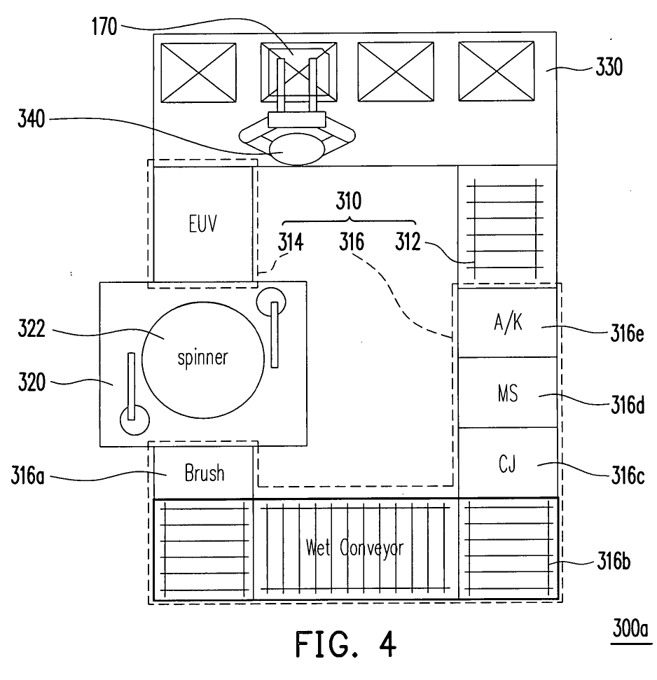

FIG. 4 is a schematic top view showing a wet-processing apparatus according to another embodiment of the present invention. Referring to FIG. 4, the wet-processing apparatus 300a of the present invention includes the conveyor type cleaning system 310, the spinner type wet-processing unit 320 connected to the conveyor type cleaning system 310, a cassette station 330 for storing the substrates 170 and a robot 340 installed in the cassette station 330. In the present embodiment, the substrates 170, such as wafers or glass substrates etc. are delivered from the cassette station 330 to the conveyor type cleaning system 310 by the robot 340.

As shown in FIG. 4, the conveyor type cleaning system 310 includes a pre-cleaning unit 314 disposed between the cassette station 330 and the spinner type wet-processing unit 320, a post-cleaning unit 316 connected to the spinner type wet-processing unit 320 and a dry conveyor 312 disposed in the pre-cleaning unit 314 and the post-cleaning unit 316. Specifically, the substrates 170 are delivered from the cassette station 330 to the pre-cleaning unit 314 by the robot 340. In the conveyor type cleaning system 310, the substrates 170 are conveyed from the pre-cleaning unit 314 to the spinner type wet-processing unit 320 and the post-cleaning unit 316 sequentially by the dry conveyor 312. Further, the dry conveyor 312 may connect the post-cleaning unit 316 and the cassette station 330, such that the substrates 170 after cleaning can be conveyed to the cassette station 330.

In the present embodiment, the pre-cleaning unit 314 is an excimer ultraviolet cleaning unit. In the pre-cleaning unit 314, a surface treatment is performed by irradiating EUV on the wafers or glass substrates 170 to generate ozone (O₃) such that organic material on the wafers or glass substrates 170 is removed and contact angle of the wafers or glass substrates 170 is reduced by ozone. However, the pre-cleaning process of the present embodiment is not limited to the EUV cleaning; other surface treatment may be performed in the pre-cleaning unit 314.

After the substrates 170 are pre-treated in the pre-cleaning unit 314, the substrates 170 are conveyed to the spinner type wet-processing unit 320 to perform wet process, such as slice-etching, wet-etching, layer stripping or development.

In the present embodiment, the post-cleaning unit 316 includes a brushing unit 316a, a wet conveyor 316b, a cavitation jet unit 316c and a mega-sonic unit 3160d. The brushing unit 316a, the wet conveyor 316b, the cavitation jet unit 316c and the mega-sonic unit 316d are arranged alone the conveying path of the dry conveyor 312 sequentially. In addition, the post-cleaning unit 316 of the present invention further includes a drying unit 316e optionally.

In the post-cleaning unit 316, the substrates 170 are conveyed to the brushing unit 316a, the wet conveyor 316b, the cavitation jet unit 316c and the mega-sonic unit 316d sequentially by the dry conveyor 312 such that particles on the substrates 170 can be removed effectively. Then, the substrates 170 are conveyed continuously to the drying unit 316e such that the substrates 170 can be dried entirely. Ultimately, the substrates 170 are delivered to the cassette station 330 by the dry conveyor 312 and the robot 340.

In the wet-processing apparatus 300 and 300a, the ability of removing particles dropped on the substrate 170 is better because the particles can be easily removed by the brushing unit 316a and the cavitation jet unit 316c of the post-cleaning unit 316. Besides, the substrate broken frequency is lowered because the substrates 170 are dried by the conveyor type cleaning system 310. Even if the substrates 170 break, fragments of the substrates 170 can be obviated rapidly. Moreover, in the wet-processing apparatus 300 and 300a, chemical consumption is lowered because of the spinner type wet-processing unit 320.

As described above, the wet-processing apparatus of the present invention at least provides the following advantages:

The wet-processing apparatus of the present invention has excellent process uniformity, low consumption of the chemical, good cleaning ability, and low substrate broken frequency such that the yield of the products manufactured by the wet-processing apparatus is improved.

In the wet-processing apparatus of the present invention, when the substrates break, fragments of the substrates can be obviated rapidly such that the hardware performance is enhanced.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, various modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A conveyor type wet-processing apparatus for processing substrates, comprising:
a conveyor type cleaning system; and
a spinner type wet-processing unit, connected to the conveyor type cleaning system.

2. A conveyor type wet-processing apparatus of claim 1, further comprising:
a cassette station for storing the substrates; and
a robot installed in the cassette station, wherein the substrate is delivered from the cassette station to the conveyor type cleaning system by the robot.

3. A conveyor type wet-processing apparatus of claim 2, wherein the conveyor type cleaning system comprises:
a pre-cleaning unit disposed between the cassette station and the spinner type wet-processing unit;
a post-cleaning unit connected to the spinner type wet-processing unit; and
a conveyor disposed in the pre-cleaning unit and the post-cleaning unit, wherein the substrates are conveyed from the pre-cleaning unit to the spinner type wet-processing unit and the post-cleaning unit sequentially by the conveyor.

4. A conveyor type wet-processing apparatus of claim 3, wherein the pre-cleaning unit comprises an excimer ultraviolet cleaning unit.

5. A conveyor type wet-processing apparatus of claim 3, wherein the post-cleaning unit comprises a brushing unit, a wet conveyor, a cavitation jet unit, a mega-sonic unit or the combinations thereof.

6. A conveyor type wet-processing apparatus for processing substrates, comprising:
a cassette station for storing the substrates;
a spinner type wet-processing unit;
a conveyor type cleaning system, connected to the spinner type cleaning system, wherein the conveyor type cleaning system comprises:
a pre-cleaning unit disposed between the cassette station and the spinner type wet-processing unit;
a post-cleaning unit connected to the spinner type wet-processing unit;
a drying unit connected to the post-cleaning unit;
a conveyor disposed in the pre-cleaning unit, the post-cleaning unit and the drying unit, wherein the substrates are conveyed from the pre-cleaning unit to the spinner type wet-processing unit, the post-cleaning unit and the drying unit sequentially by the conveyor; and
a robot installed in the cassette station, wherein the substrate is delivered from the cassette station to the conveyor type cleaning system by the robot.

7. A conveyor type wet-processing apparatus of claim 6, wherein the pre-cleaning unit comprises an excimer ultraviolet cleaning unit.

8. A conveyor type wet-processing apparatus of claim 6, wherein the post-cleaning unit comprises a brushing unit, a wet conveyor, a cavitation jet unit, a mega-sonic unit or the combinations thereof.

9. A conveyor type wet-processing apparatus of claim 6, wherein the drying unit comprises an air knife.

10. A conveyor type wet-processing apparatus of claim 1, wherein the spinner type wet-processing unit comprises an etcher, a stripper or a developer.

11. A treatment of substrates, comprising:
performing a cleaning process on the substrates by a conveyor type cleaning system;
performing a wet-process on the substrates by a spinner type wet-processing unit connected to the conveyor type cleaning system.

12. A treatment of substrates of claim 11, wherein the cleaning process comprises:
performing a pre-cleaning process on the substrates by a pre-cleaning unit;
performing a post-cleaning process on the substrates by a post-cleaning unit after performing the wet-processing; and
performing a drying process on the substrates by a drying unit connected to the post-cleaning unit.

13. A treatment of substrates of claim 11, wherein the wet-process comprises a slice etch process, a wet etch process, a stripper, or a developer.
